(19) United States
(12) Patent Application Publication
(10) Pub. No.: US 2006/0288770 A1
(43) Pub. Date: Dec. 28, 2006

(54) Method for determining remaining operational life of a cable

(76) Inventor: Ralf Nowack, Mulheim (DE)

Correspondence Address: ROBERT W. BECKER & ASSOCIATES, 707 HIGHWAY 333, SUITE B, TIJERAS, NM, 87059-7507, US

(21) Appl. No.: 10/571,046

(22) PCT Filed: Aug. 27, 2004
(86) PCT No.: PCT/EP04/09555

§ 371 Date: Mar. 3, 2006

(30) Foreign Application Priority Data
Sep. 4, 2003 (DE) 103-40-713.8

(51) Int. Cl. G01L 5/04

(52) U.S. Cl. 73/158

(57) ABSTRACT

A method for determining remaining operational life of elastic cables composed of individual filaments, including establishing a fatigue curve for the cable filaments, producing a test cable from the cable material, determining the minimum breaking load of test cable sections, placing the test cable adjacent to an elastic cable, removing sections at prescribed time intervals and determining the minimum breaking load for each to form a coefficient A with reference to the original minimum breaking load of the sections and establishing an environment-dependent curve against time from all coefficients A, associating with each coefficient A a coefficient B that, for the removal time, is determined from the fatigue curve based on a load spectrum, multiplying coefficients A and B together to form reduction factors, after the test phase dismantling the elastic cable, determining its remaining strength and comparing it with the original minimum breaking load to form an actual reduction factor, forming current reduction factors of a future cable from coefficients A and B, and estimating remaining operational life of the future cable from its current reduction factor, including a safety factor.

The invention relates to a method for determining the remaining operational life of elastic hawsers or cables that are composed of individual filaments and serve for mooring a vessel to a pertaining buoy.

If no protected port is available, large ships must unload offshore into smaller vessels, which themselves can only approach the coast under favorable weather conditions. If the weather is bad, the vessels must wait offshore for the weather to pass. If the smaller vessels have their own motor, they can ride out the bad weather offshore. This is prohibited for vessels that do not have their own drive means, and they must therefore be moored to a pertaining buoy until the weather conditions allow an approach to the coast.

For this purpose, the elastic cables, which are composed of individual filaments, are utilized, and in particular a single cable per vessel. The cables need to be elastic in order to be able to absorb loads or stresses that occur. Due to the elasticity of the cables, the loads that occur in the order of magnitude of several thousand tons can be reduced to an order of magnitude of several hundred tons. A prerequisite is that under extreme conditions the cables can stretch by more than 30%.

Experience has shown that suitable for this purpose are nylonindividual filament cables having a length of several hundred meters and a diameter of from 10 to 20 cm. Such cables are, of course, expensive. In addition, there are considerable costs involved for installation, transport, mobilization, fees, etc.

Up to now, there has been no possibility for reliably assessing or estimating the operational life of the cables. For safety reasons, the manufacturers therefore specify replacement of the cables after 6 to 12 months.

The object of the invention is to enable a replacement of the cables based on operational life.

To realize this object, the inventive method is characterized by
plotting a fatigue curve for the filaments of the cable via dynamic tests,
producing a test cable from the material of the cable, wherein the test cable is comprised of a number of sections that are detachably connected to one another,
determining the minimum breaking load of the sections of the test cable,
mooring the vessel to the pertaining buoy via one of the elastic cables accompanied by the interposition of a load-carrying system,
placing the test cable adjacent to the elastic cable,
removing sections from the test cable at prescribed time intervals,
determining the minimum breaking load for each removed section of the test cable and forming a first coefficient A with reference to the original minimum breaking load, wherein the first coefficient represents the loss of carrying strength as a consequence of environmental influences,
from the coefficients A determined for all of the sections of the test cable, plotting an environment-dependent curve against time,
associating with each first coefficient A a second coefficient B that, for the point in time of the removal of the pertaining section of the test cable, is determined from the fatigue curve on the basis of the load spectrum (load frequency and strength over time) supplied by the load-monitoring system, wherein the second coefficient represents the loss of carrying strength as a consequence of the load influences,
multiplying the pair of coefficients A and B together to form reduction factors,
at the conclusion of the test phase, dismantling the elastic cable, determining its remaining strength, and comparing it with the original minimum breaking load to form an actual reduction factor, thus enabling a comparison with the reduction factor determined at the same point in time via the test cable;
forming the actual reduction factors of a future cable from the coefficient B, which is determined from the fatigue curve and the actual load spectrum, as well as from the coefficient A, which is read from the environment-dependent curve,
estimating the remaining operational life of a future cable from the actual reduction factors thereof, including a safety factor.

The invention is based on the recognition that the operational life of the elastic cable is a function, on the one hand, of the mechanical loads, namely of their magnitude as well as the number of load changes, and on the other hand of the respective environmental conditions which, of course, can vary from one location of use to another. Entering into the load spectrum are, in addition to the wave spectrum (height, length and frequency of the waves), primarily also wind and flow conditions. The environmental influences are primarily determined by the salt content and the temperature of the water, the intensity of the UV radiation, and the water biology, which is crucial for the growth of algae on the cable. The capacity of the cable to absorb water also plays a role.

The method of the invention enables an overlapping of these parameters. The first coefficient A takes into account the loss of carrying strength of the cable that results from the actual environmental influences, while the second coefficient B represents the loss of carrying strength that results from the load spectrum. The combination of the two coefficients then results in the actual reduction factor.

Calculations are made with the minimum breaking load, since this can be determined experimentally and compared with the specifications of the manufacturer. Determinative is, of course, that load that maintains a prescribed safety zone to the minimum breaking load. An appropriate allowance is effected by using the safety factor.

The reduction factor, which is <1, is multiplied with the original minimum breaking load and results in the remaining minimum breaking load, which permits an estimation of the remaining operational life and includes the safety factor.

The number of test cable sections, and the removal cycle, are preferably selected such that the operational life of the elastic cable recommended by the manufacturer can be exceeded. Such an exceeding can be risked if, from the remaining strength that is determined via the test cable, the result is that a considerable potential of remaining strength is still available. Under these conditions, the elastic cable can still remain in operation for a certain period of time without danger. If the cable is then dismantled, one can demonstrate that the actual remaining strength of the elastic cable coincides with the remaining strength determined via the test cable.

The reduction factors of the test cable sections are preferably plotted as a remaining strength curve against time, whereby the particularly advantageous possibility exists of being able to extrapolate the remaining strength curve beyond the test phase.

For reasons of practicability, it is recommended to use a test cable having a diameter that is less than that of the elastic cable. As mentioned, the diameter of the elastic cable is 10 to 20 cm. 4-5 cm have proven to be satisfactory as a diameter for the test cable.

To subject the test cable to exactly the same environmental conditions as the elastic cable, it is advantageous to connect the two cables to one another. With respect to the difference in diameter, this is of negligible significance for the rigidity of the elastic cable. However, the important thing is that the mutual connection be free of friction in order to reliably exclude influences relating thereto on the carrying strength of the two cables.

A removal of the test cable sections based on time intervals of three months represents an optimum compromise, and in particular on the one hand with respect to the effort for establishing the remaining strength curve, and on the other hand with respect to the precision thereof.

Pursuant to a significant further development of the invention, it is proposed that the determination of the minimum breaking load of the removed test cable sections be carried out by tests on the sections themselves or by individual filament tests on the filaments thereof, as a function of a comparison between the results of preliminary tests and the manufacturer specifications. One selects that determination method that results in the greatest degree of correlation with the specifications of the manufacturer.

The dynamic tests for establishing the fatigue curve are advantageously carried out on individual filaments, with a further advantageous feature being to establish the fatigue curve similar to a Wöhler curve.

Pursuant to a further development of the invention, the coefficients B are determined by using the “Palgren-Miner-Hypothesis”, which originates with the steel industry.

It is proposed pursuant to a further development of the invention to use a test cable whose length does not fall below the minimum length of the wave lengths that are predominantly to be anticipated at the location. This can be done by selecting the length in conformity with the individual sections of the test cable, which under certain circumstances can be very expensive. Therefore, it can be advantageous to connect the test cable with the pertaining buoy via an extension section. In this connection, only the extension section must be adapted to the wave lengths that are predominantly to be expected at the location.

Pursuant to another advantageous embodiment of the invention,
loops are spliced onto the ends of the test cable sections,
the loops of adjacent sections are overlapped or superimposed, and
the cords of the superimposed loops are wrapped around.

This represents a very simple connection between the individual sections, which furthermore can be detached without a problem.

A preferred embodiment of the inventive method will be explained in greater detail below with the aid of the accompanying drawings, in which:

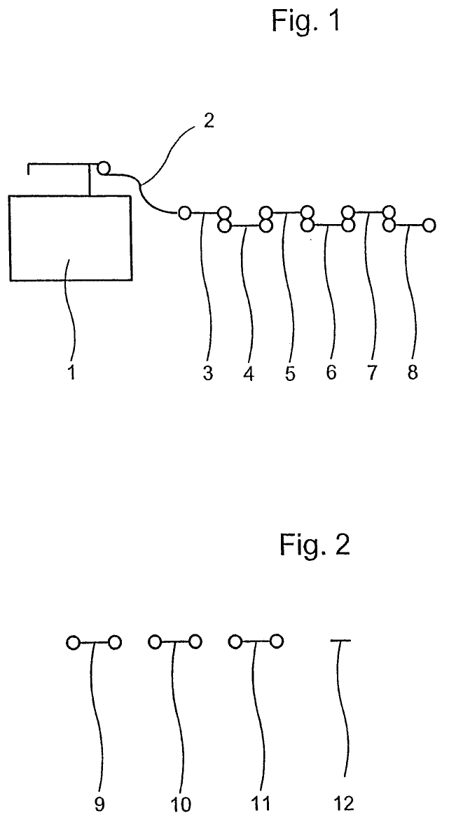

FIG. 1 schematically illustrates a test cable;

FIG. 2 shows an assembly of the elements that are additionally to be ordered.

The test cable of FIG. 1 is secured to a buoy 1. This buoy also serves for the securement of the non-illustrated elastic cable to which an also not illustrated vessel is moored in the case of a storm. The test cable comprises an extension section 2, the length of which is adapted to the minimum length of the wave lengths that are predominantly to be anticipated at the location, and also comprises six following sections, namely the sections 3-8. The sections 3-8 are of the same length and, as does the section 2, have a diameter of 4.5 cm. In comparison thereto, the diameter of the elastic cable is 16 cm. As indicated schematically, the sections 2-8 are detachably connected to one another.

FIG. 2 shows three further sections 9-11, which correspond to the sections 3-8, as well as a section 12 having no securement ends, which serves for the removal of individual filaments.

The filaments of the test cable, with the exception of their length, correspond with the filaments of the elastic cable.

The manufacturer of the cable has provided details regarding the minimum breaking load of the test cable. These details are checked using the sections 9-11. By using three sections, fluctuations can be averaged out. At the same time, tests are carried out on individual filaments that have been removed from the section 12. The minimum breaking load of the sections 3-8 is determined from these individual filament tests pursuant to DIN EN 919. Subsequently, the test results are compared with the details or specifications delivered by the manufacturer, and a decision is made whether the checking of the sections 3-8 after their removal should be undertaken according to the first mentioned method or according to the second mentioned method.

Also belonging to the preliminary tests is the establishment of an S-N-fatigue curve, similar to a Wöhler curve and in particular on the basis of the individual filaments that have been removed from the section 12. With this, the preliminary tests are concluded.

The elastic cable is subsequently laid, and is secured to the buoy 1, in particular accompanied by the interposition of the non-illustrated load-monitoring system. The test cable is then laid, and is connected with the elastic cable in a friction-free manner.

After three months have elapsed, the section 8 is removed from the test cable and its minimum breaking load is determined, and in particular, as a function of the aforementioned decision, either by testing the section itself or by testing individual filaments. Relative to the original minimum breaking load, there results a factor A that represents the loss of carrying strength or capacity as a consequence of environmental influences.

Furthermore, the previously determined fatigue curve, via the “Palgren-Miner-Hypothesis”, is linked with the load spectrum supplied by the monitoring system at the point in time of the removal of the section 8, resulting in a factor B that represents the loss of carrying strength or capacity as a consequence of load influences.

The factors A and B are multiplied with one another and yield a reduction factor.

The sections 7, 6 and 5 are handled in the same manner.

The coefficients of sections 8 to 5 are plotted against time as an environment-dependent curve. Furthermore, a remaining strength curve that is dependent on the load spectrum and on the environment can be established from the reduction factors, and represents not only the environmental but also the load influences.

By the time the section 5 has been removed, one year has elapsed. If the remaining strength curve shows that a considerable excess of remaining strength is present, the test series continues with the sections 4 and 3.

After the dismantling of the elastic cable, its remaining strength, in other words the actual minimum breaking load, is determined, whereby with respect to the diameter of the elastic cable, merely individual filament tests are involved. A comparison with the remaining strength that is determined via the test cable at the point in time of dismantling of the elastic cable ensures that the remaining strength coincides with the actual remaining strength of the elastic cable. If necessary, an extrapolation of the remaining strength curve is possible.

To determine the operational life of a future elastic cable, the coefficient B is determined at time intervals, and in particular on the basis of the actual load spectrum and the existing fatigue curve, by application of the “Palgren-Miner-Hypothesis”. In addition, for the same point in time the coefficient A is read from the environment-dependent curve. A multiplication of the coefficients A and B results in the actual reduction factor <1, which by multiplication of the original minimum breaking load leads to the actual remaining strength. The remaining operational life can then be estimated using the safety factor.

Possibilities for variations readily exist within the scope of the invention. For example, the extension section 2 can be dispensed with if the sections 3-8, relative to the wave lengths that are predominantly to be expected at the location, are long enough. Furthermore, the test series is not limited to six sections; rather additional sections can readily be provided that extend the test period correspondingly. The latter is also possible by lengthening the removal cycle of the sections. However, the removal cycle can also be shortened if differentiated results are desired.

One must generally assume that the critical parameters will differ from one location of use to another. Accordingly, a special test series will be required for each location of use. The same applies with respect to different cable material. However, if identical conditions exist, the results are transferable.

1-13. (canceled)

14. A method for determining the remaining operational life of elastic cables that are composed of individual filaments and serve for mooring a vessel to a buoy, including the steps of:
a fatigue curve for the filaments of a cable via dynamic tests;
producing a test cable from the material of the cable, wherein said test cable is comprised of a number of sections that are detachably connected to one another;
determining the minimum breaking load of said sections of said test cable;
mooring the vessel to the buoy via one of the elastic cables accompanied by the interposition of a load-monitoring system;
placing said test cable adjacent to the one elastic cable;
removing said sections from said test cable at prescribed time intervals;
determining the minimum breaking load for each removed test cable section and forming a first coefficient A with reference to the previously determined minimum breaking load of said sections, wherein said first coefficient A represents a loss of carrying strength as a consequence of environmental influences;
from said first coefficients A determined for all of said test cable sections, establishing an environment-dependent curve against time;
associating with each first coefficient A a second coefficient B that, for the point in time of the removal of a pertaining test cable section, is determined from the fatigue curve on the basis of a load spectrum supplied by said load-monitoring system, wherein said second coefficient B represents the loss of carrying strength as a consequence of the load influences;
multiplying said first and second coefficients A and B together to form reduction factors;
at the conclusion of the foregoing test phase, dismantling said elastic cable, determining its remaining strength, and comparing it with the previously determined minimum breaking load to form an actual reduction factor, thus enabling a comparison with the reduction factor determined for the same point in time via said test cable;
forming current reduction factors of a future cable from said second coefficient B, which is determined from the fatigue curve and the current load spectrum, and from said first coefficient A, which is read from the environment-dependent curve; and
estimating the remaining operational life of said future cable from the actual reduction factors thereof, including a safety factor.

15. A method according to claim 14, wherein said reduction factors of said test cable sections are established as a remaining strength curve against time.

16. A method according to claim 15, wherein said remaining strength curve is extrapolated beyond said test phase.

17. A method according to claim 14, which includes the step of using a test cable having a diameter that is smaller than a diameter of said elastic cable.

18. A method according to claim 14, wherein said test cable is connected with said elastic cable in a friction-free manner.

19. A method according to claim 14, wherein said test cable sections are removed at time intervals of three months.

20. A method according to claim 14, wherein the step of determining the minimum breaking load of the removed test cable sections is carried out by tests on the removed sections themselves or by individual filament tests on the filaments thereof, as a function of a comparison between results of preliminary tests and manufacturer specifications.

21. A method according to claim 14, wherein said dynamic tests for establishing the fatigue curve are carried out one individual filaments.

22. A method according to claim 14, wherein said fatigue curve is established similar to a Wöhler curve.

23. A method according to claim 14, wherein said coefficients B are determined by using the “Palgren-Minor-Hypothesis”.

24. A method according to claim 14, which includes the step of using a test cable that has a length that does not fall below the minimum length of wave lengths that are to be predominantly expected at a location of application of the method.

25. A method according to claim 24, wherein said test cable is connected to said buoy via an extension section.

26. A method according to claim 14, which includes the further steps of
splicing loops onto ends of said test cable sections,
superimposing loops of adjacent test cable sections, and
wrapping around cords of said superimposed loops.
